(19) United States
(12) Patent Application Publication
(10) Pub. No.: US 2020/0010193 A1
(43) Pub. Date: Jan. 9, 2020

(54) Method and Apparatus for Unmanned Aerial Maritime Float Vehicle That Sense and Report Relevant Data from Physical and Operational Environment

(71) Applicant: DWIGHT DARWIN ALEXANDER, LEWISBURG, PA (US)

(72) Inventor: DWIGHT DARWIN ALEXANDER, LEWISBURG, PA (US)

(21) Appl. No.: 16/027,310

(22) Filed: Jul. 4, 2018

(51) Int. Cl. B64C 39/02; B63G 8/00; B64C 25/54

(52) U.S. Cl. CPC B64C 39/024; B63G 8/001; B64C 2201/12; B63G 2008/007; B64C 2201/024; B64C 25/54

(57) ABSTRACT

Method and apparatus for unmanned aerial maritime float vehicle that sense and report relevant data from physical and operational environment. The apparatus is comprised of an unmanned aerial vehicle and cabled unmanned underwater vehicle. The method wherein a end-user's controller is coupled wirelessly to the unmanned aerial vehicle transceiver to allow relevant live data to be collected from sky and ground, Upon landing on a water's surface the cable is repelled and control signals and data are transmitted to the cabled unmanned underwater vehicle transceiver, thus high speed feedback and sensor signals can be transmitted from the cabled UUV back to the UAV then both the UUV and UAV high speed feedback and sensor signals are wirelessly sent back to the user's controller through the UAV.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to improved method and apparatus for monitoring the ground, sky and water. More particularly, the invention relates to such a method and apparatus for unmanned aerial maritime float vehicle that sense and report relevant data from physical and operational environment. The method for ground, sky and water observation according to prior art is well known. It's very common for a person who wishes to obtain relevant data from the sky and ground around them to use a unmanned aerial vehicle. Then travel to said location to deploy unmanned underwater vehicle into the body of water from the shore or boat to obtain the relevant data from the body of water.

There several basic problems in this method of ground, sky and water observation. First, there no known unmanned aerial vehicles cabled to unmanned underwater vehicle. It's often the reason that the ground, sky and water surfaces are only investigated separately. Second, a cabled unmanned underwater vehicle is limited to stay in water near the user's position. It's the reason why users are confined to a shore line or a boat if available. Third, a cabled unmanned underwater vehicle is limited to stay in water near the user's position. It's the reason why users are confined to a shore line or a boat if available. Fourth, unmanned underwater vehicles are dropped off into the water by an unmanned aerial vehicle. It's the reason why most unmanned underwater vehicles are not retrieved, live data is transmitted till the batteries are dead and the depth is limited due to signal weakening underwater. Last but not least, the submersible drones capable of exploring underwater and air are connected to the user's controller. It's the reason why users are confined to a shore line or a boat if available.

### BRIEF SUMMARY OF THE INVENTION

The current invention is directed method and apparatus for unmanned aerial maritime float vehicle (UAMFV) that sense and report relevant data from physical and operational environment. The UAMFV has a propulsion systems and directional controls that allow an operator to control the speed and direction of the UAMFV through the air and across water surface. The UUV may have a propulsion system that allow an operator to control the speed and direction of the UUV through a body of water. The sensors and feedback devices that can provide information is transmitted back to the end-user controller or any other receiver.

The UAV may be coupled to the UUV with a cable. A controller can be wirelessly coupled to the UAMFV transceiver where signals can now be transmitted or received through the UAV and cabled UUV transceiver so the operator can transmit and receive data from both the UUV and UAV. For example, the operator's controller is coupled wirelessly to the UAV to perform the actions of the control signals, upon landing in water the controller is mode is switched and the control signals are now transmitted to the UUV from UAV to perform the actions of the control signals. The sensor and feedback signals produced by the UUV are transmitted back to the UAV then wirelessly transmitted back to the operator's controller or any other receiver.

The distance of the UAV can be limited by the strength of the wireless controller transceiver. The diving depth of the UUV can be limited by the length of cable or strength of wireless connection between UAV and UUV. The cable can have various lengths and diameters. A large diameter cable will be stronger but will also result in more drag forces as the UUV moves through the water and adds a heavier payload that the UAMFV needs to tow thus limiting decreasing flight time. The method and apparatus solves the problem of remotely controlling a device capable of traveling through any sky and body of water while being in full high speed data communication.

### BRIEF DESCRIPTION OF THE SEVERAL VIEWS OF THE DRAWING

FIG. 1 illustrates a front elevational view of UAMFV according to the present invention;

FIG. 2 illustrates a top elevational view thereof;

FIG. 3 illustrates a perspective elevational view thereof;

FIG. 4 illustrates a side elevational view thereof;

FIG. 5 illustrates a perspective elevational view of the UUV with the cable;

FIG. 6 illustrates a front elevational view of winch holding the cable with a alignment mechanism, and UUV;

FIG. 7 illustrates various phases 1-3 that will be used to more clearly illustrate how the UAMFV of FIG. 1 may operate;

FIG. 8 illustrates a alternative of a block diagram of the system utilizing the cable as a communication between the UUV and UAV to be used in the present invention;

FIG. 9 illustrates a alternative of a block diagram of the system utilizing wireless communications between the UUV and UAV to be used in the present invention;

FIG. 10 illustrates a stepwise flow diagram describing the general process of the present invention;

FIG. 11 illustrates a stepwise flow diagram describing additional steps for communication between UUV, UAV and end user controller;

FIG. 12 is a stepwise flow diagram describing steps for designating one of plurality of vehicles for the end user to operate;

FIG. 13 illustrates a stepwise flow diagram describing steps for returning a UAMVF to a charging location; and

FIG. 14 illustrates a front elevation front view of UAMFV on water surface.

### DETAILED DESCRIPTION OF THE INVENTION

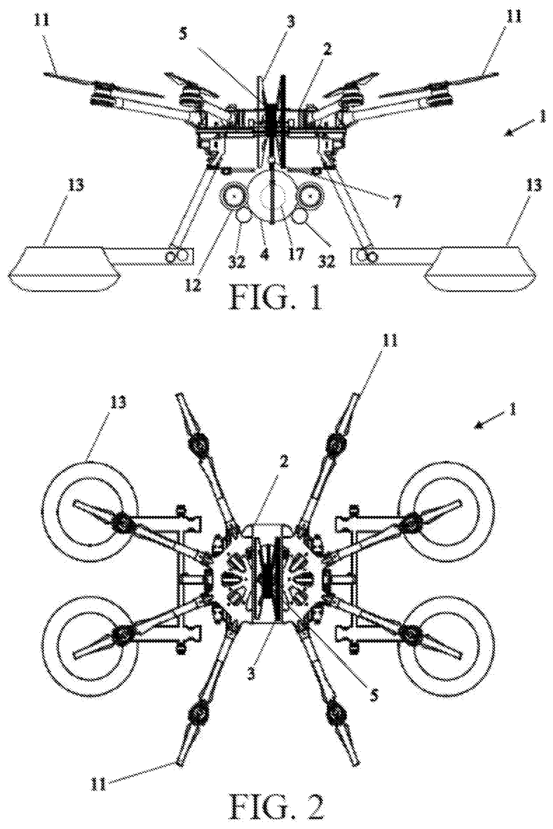

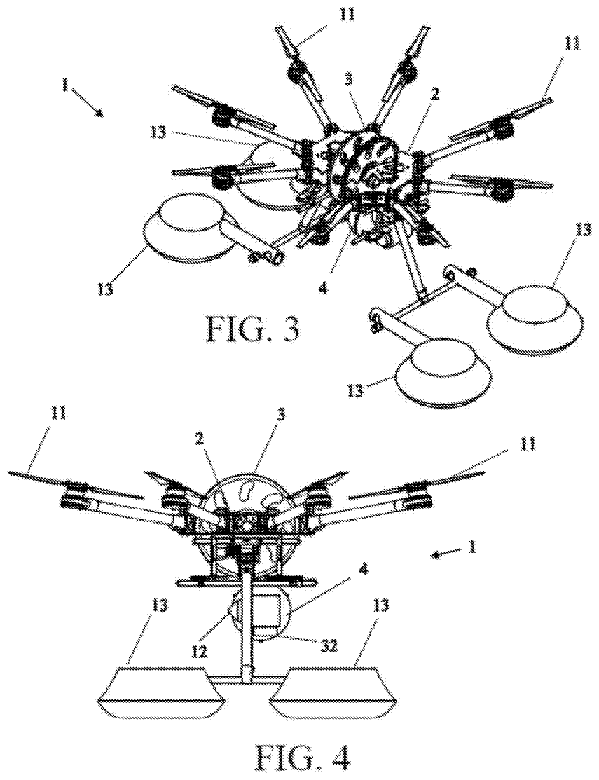

Referring now in detail to the drawing and, in particular to FIG. 1-6, there is illustrated an apparatus for unmanned aerial maritime float vehicle (UAMFV) that sense and report relevant data from physical and operational environment with a UAMFV 1. The present invention includes unmanned aerial vehicle (UAV) 2 which has floats 13, winch 3, end-user controller 6, alignment mechanism 7, propellers 11, unmanned underwater vehicle (UUV) 4, sensors 17, ballast tanks 32, cable 5, and prop rotors 12.

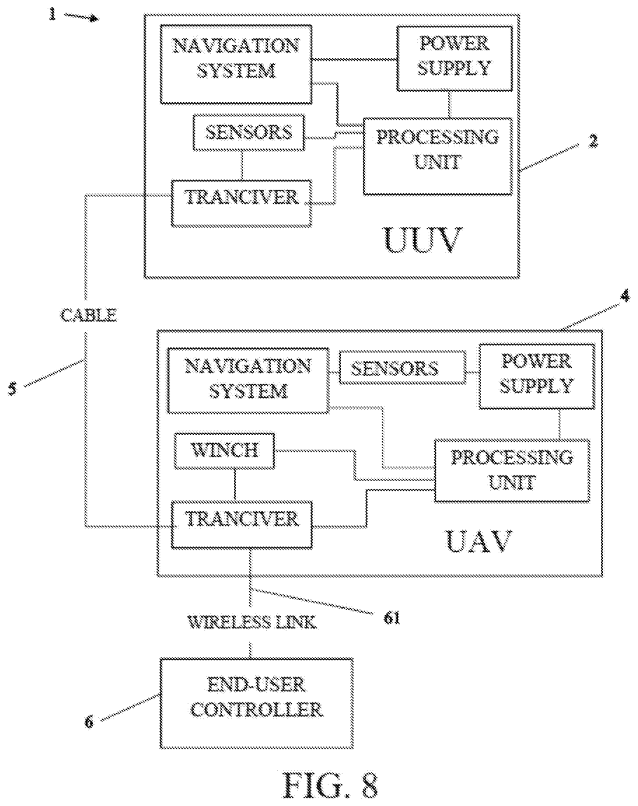

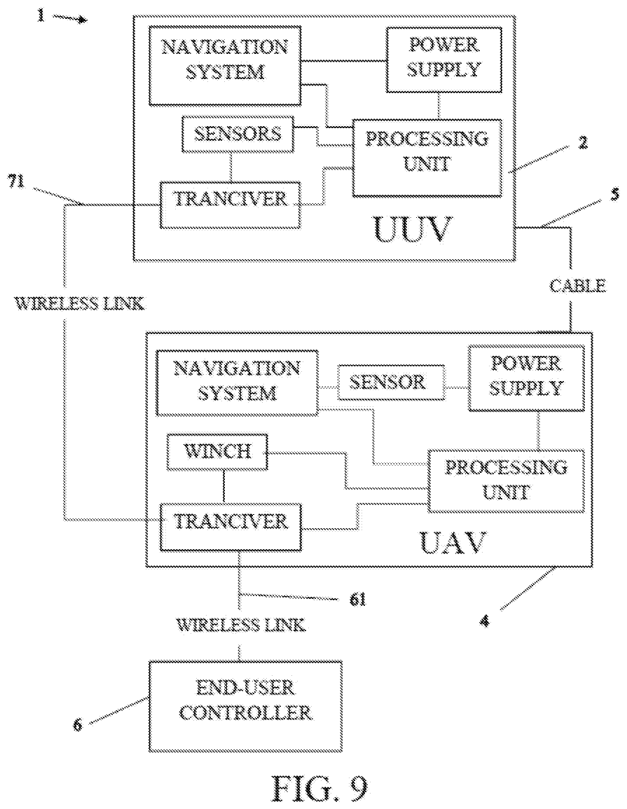

Referring now in detail to FIGS. 8 and 9. There are several configurations to getting communication systems with the current method between the UAV 2 and UUV 4; this will only be showing two. Depending on the cable being used as just a tow cable or communications cable determines the configuration, as you can see in FIG. 8 the UAMFV is using a alternative of wired and wireless connection and FIG. 9 UAMFV is showing a alternative of wireless connections, however no matter the configuration, a cable coupling the UAV 2 to a UUV 4 is used and a constant communication between the UAV 2 and UUV 4 is kept. Specifically referencing FIG. 8 the wireless controller 6 enables high bandwidth communication between the controller and the UAV 2 through transceivers. The cable 5 may be used to connect the high bandwidth communication between the UUV 4 and UAV 2. Also electrical signals, may be sent through the cable 5 to travel to the conductor(s) transceivers or be powered by a separate powers supply in each the UUV 4 and UAV 2. For three way communications, the end user controller 6, UAV 2, and UUV 4 will each have a transceiver. In order to drive the UAMFV 1, an alternative means of power is required; a power supply is required on the UAV 2 or/and UUV 4. For the high speed feedback and sensor data to be communicated between the controller and the UUV 2. First, control instructions for the UUV 4 will be transmitted wirelessly from the end user controller 6 through the wireless link 61 to UAV 2 transceiver. Second, the control signals are forwarded to the UUV 4 transceiver by the UAV 2 transceiver through a wired link through cable 5. The control signals received from the controller 6 through the UAV 2 a are then executed by the UUV 4. Third, the high speed feedback and sensor 17 signals collected from the UUV 4 are wire transmitted from the UUV 4 transceiver to the UAV 2 transceiver through cable 5. Last but not least, the high speed feedback and sensor signals from the UUV 4 will be sent through wireless link 61 back to the end user's controller 6 from the UAV 2.

Specifically referencing FIG. 9 the wireless controller 6 enables high bandwidth communication between the controller and the UAV 2 through transceivers. The cable 5 may just be used as a tow point between the UUV 4 and UAV 2. The communications between the UUV and UAV, in this case signals will be travelling by wireless connection 71. Electrical signals, may be sent through the cable 5 to travel to the conductor(s) transceivers or be powered by a separate powers supply in each the UUV 4 and UAV 2. For three way communications, the end user controller 6, UAV 2, and UUV 4 will each have a transceiver. In order to drive the UAMFV 1, an alternative means of power is required; a power supply is required on the UAV 2 or/and UUV 4. For the high speed feedback and sensor data to be communicated between the controller and the UUV 2. First, control instructions for the UUV 4 will be transmitted wirelessly from the end user controller 6 through the wireless link 61 to UAV 2 transceiver. Second, the control signals are forwarded to the UUV 4 transceiver by the UAV 2 transceiver through a wireless link 71. The control signals received from the controller 6 through the UAV 2 a are then executed by the UUV 4. Third, the high speed feedback and sensor 17 signals collected from the UUV 4 are wirelessly transmitted from the UUV 4 transceiver to the UAV 2 transceiver by wireless link 71. Last but not least, the high speed feedback and sensor signals from the UUV 4 will be sent through wireless link 61 back to the end user's controller 6 from the UAV 2.

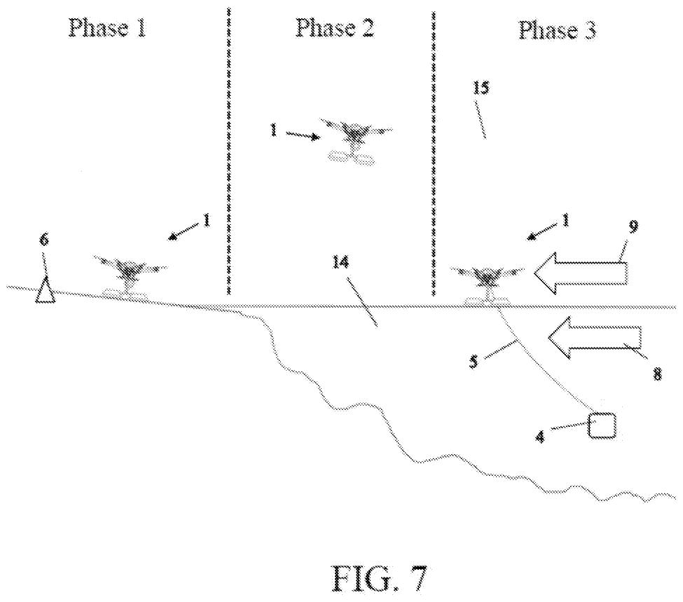

Referring now in detail to FIG. 7 As the UUV 4 moves through the body of water 14, the cable 5 is pulled in tension and the surface UAV 2 is towed across the surface of the water. In an embodiment the maximum length of the cable 5 will be depend on the type of cable being used and the drag generated by the cable 5. The UUV will have to have sufficient thrust to overcome the water current 8 on the UUV and the drag forces applied to the UUV. A wider cross section cable 5 will cause more drag as it moves through the water and therefore a wider cable may need to be shorter in length for the UUV to overcome the drag forces than a thinner cross section cable. As discussed, the cable 5 may contain an electrical conductor and optical fiber.

In some embodiments, the system can use different cables depending on the UAVs max lifting payload capabilities, the lifting force of winch 3 and the weight of the UUV 4. Instances where cable is used a connector terminates the end of a connectors. And enable quicker connection and disconnection than splicing. The connectors mechanically couple and align the cores so that signals can pass. Most connectors are spring loaded so the two connectors are pressed together, resulting in a direct contact between both cores, avoiding any interfaces, which would be resulting in higher connector losses. A variety of connectors are available. The main differences among types of connectors are dimensions and methods of mechanical coupling.

The cable can be surrounded by a cladding of plastic layers that are coated around the outer diameter of the optical fiber. The cladding can be coated with a tough resin buffer layer, which may be further surrounded by a jacket layer which can be made of a plastic material. These layers add strength to the fiber, add to buoyancy but do not contribute to its optical waveguide properties. The jacketed fiber can be enclosed, with a bundle of high strength flexible fibrous polymer members like aramid materials. Each end of the cable may be terminated with a specialized connector to allow it to be easily connected and disconnected from the UUV and communications equipment on the UAV.

In an embodiment, the operator can select the most appropriate cable 5 length. Since the operator will typically know the required dive depth prior to releasing the UUV 4, a suitable length cable 5 can be attached between the UUV 4 and UAV 2. During the dive, the operator can control the UUV so that it does not exceed the maximum depth. The system may also contain warning mechanisms that inform the operator when UUV is reaching the maximum depth for the cable being used.

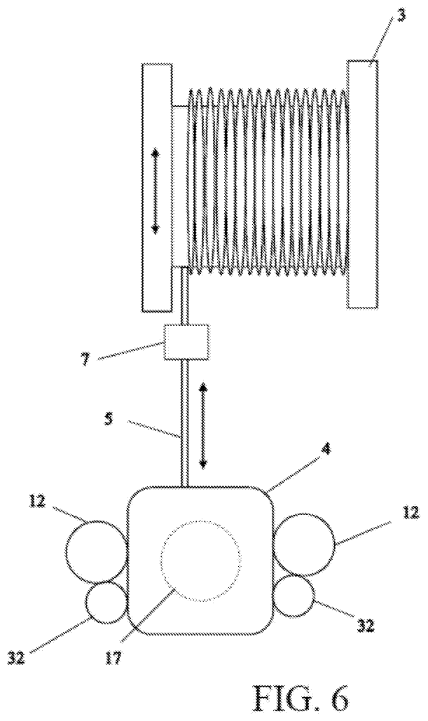

In one embodiments, the cable can be retracted into the UAVs winch 3 that is mounted adjacent to the UUV 4. With reference to FIG. 6, the cable 5 can be stored on a winch 3. The winch 3 can be rotated to release the stored cable 5 as additional length is needed or rotated to retract cable 5 as the UUV returns to the surface and moves closer to the UAV 2. This feature can be useful in simplifying the deployment and retrieval of the UUV, since the cable 5 is retracted it would not have to be retrieved separately from the UUV and UAV. Also, by only exposing the required length of the cable 5, the hydrodynamic drag of the cable is also minimized. An alignment mechanism 7 can be used to properly align the cable 5 with the winch. In an embodiment, the alignment mechanism 7 aligns the cable 5.

FIG. 7 as an illustration of deploying the UAMFV 1. Referring to FIG. 7, in phase 1, UAV 2 lifts off and hovers and begins obtaining relevant data to transmitted back to the controller 6. In phase 2, UAV 2 fly's out to the desired location and hovers. In phase 3, UAV 2 lands on a water surface, to descend the UUV 4 by unreeling cable 5. Within phase 3, the UUV 4 will be used to obtain relevant data from a body of water and be transmitted back to the UAV 2, where both the sensors and feedback from the UAV 2 and UUV 4 will be transmitting and receiving signals between the end-user's controller 6 through a wireless link 61. Next, the UAV 2, will ascend the UUV 4 out of the water by winding in the cable 5. Thereafter, the processes will repeat phases 1, 2, and 3 in numerical order to returning to a charging location.

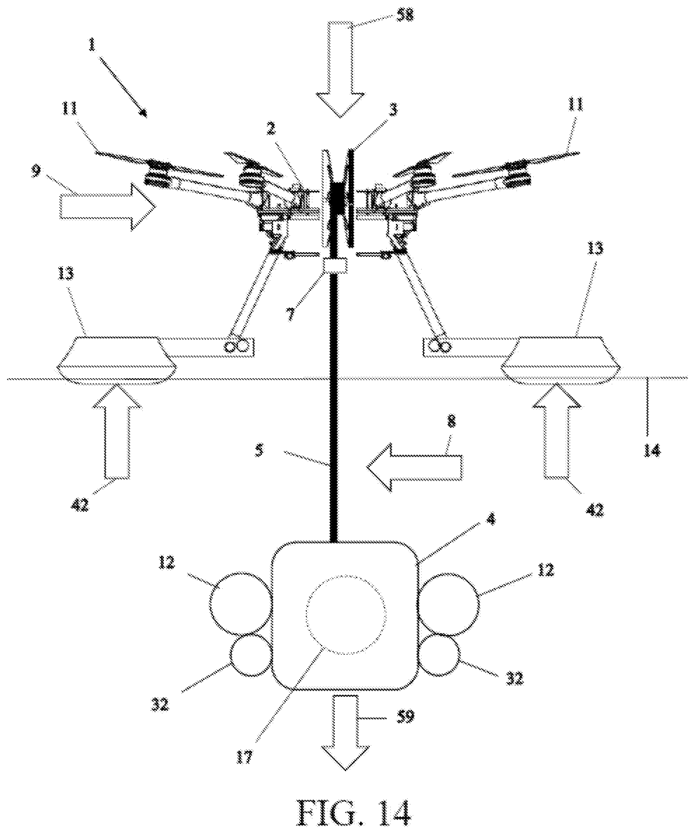

With reference to FIGS. 1-6, and 14 in order for the UUV to tow the cable connected to the UAV. The UUV 4 props 12 will need sufficient power to overcome the drag forces of cable 5 moving through the water and against any water movement due to currents 8 and the air current 9 against the UAV 2. The drag forces will act on the UUV 4 by the tension in the cable 5. Thus, a high tension will be caused by a high drag and lift force. The cable tension will typically pull the UUV 4 back and up at the angle of the cable 5 to the UUV 4. The drag forces and cable tension will increase with increases in the velocity of the cable through the water. Since the UUV 4 may be used to explore fixed objects on the sea floor, cable 5 may also be subjected to sea water current 8 and air current 9. Thus, the UUV props 12 must provide enough propulsion force to overcome the sum of the drag on the cable 5 due to UUV 2 velocity and water current 8 and UAV velocity and air current 9. Since the UAV 2 may be used to buoy the UUV 4, the UAVs floats 13 must displacement enough water to provide buoyancy force 42 and stability to overcome the sum forces of gravity 58, tension in cable 5 caused by currents 8 and 9 and force of the negative buoyancy of the UUV 59 with full ballast tanks 32.

The forces acting on the UUV also include vertical forces. The winch 3 and ballast tanks 32 of the UAV 2 must be able to provide sufficient vertical forces to overcome both the negative buoyant forces 59 of the UUV and the forces 8 and 9 creating the tension on the cable 5. Hence in order for the vehicle to move as commanded, it will need to at all times be able to generate the counter forces and vector to the tension, direction and rotational moments inflicted by the tension in the cable and its angle and place of action(s) on the vehicle.

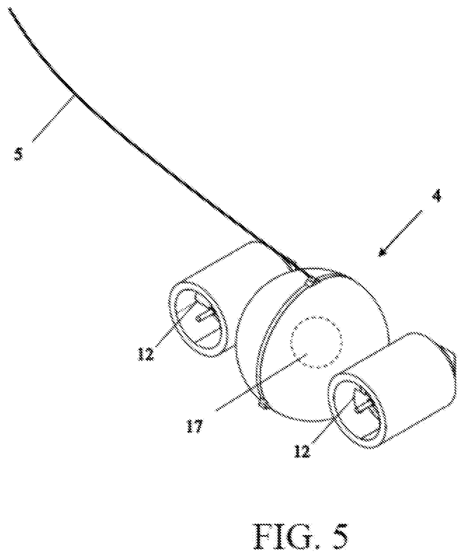

The ability of the UUV to physically move as commanded and remain under control and counter all cable forces and moments coupled to a UAV with a cable has been impractical to date, even using a minimum diameter and streamlined drag armored link. As the UAV moves, the cable tension pulls the UUV up and prevents accurate movement control. In order to overcome this problem, a ballasted submersible is required. The weight of the UUV produce strong directional forces that are able to resist the uncontrolled disruptive physical vertical pull and turning moments caused by the tow cable. In one embodiment the cable and buoy forces that result from movement of the UUV are instantly controlled by props 12 of the UUV 4 and controllable winch 3 of the UAV 2. Another embodiment is when the tension on the cable pulls the UAV 2 across the surface it uses its propellers 11 so that the cable is vertically aligned with the UUV. This allows the winch to provide both a down ward vertical force and the movement of the UAV 2 across the surface to resist the tension in the cable. The remotely controlled UUV uses multiple props 12 providing forward thrust and speed. With reference to FIG. 5, the props are instantly controllable by motors, via manual control or autopilot to quickly act as needed to counter the disruptive tow forces and moments. For example, the autopilot of the UUV 4 can include force sensors that monitor the drag tension and direction on the cable UUV. If a variation in the cable tension is detected, the system can automatically increase or decrease the thrust to counteract the change in cable tension. Thrust can be used to counteract the horizontal component of the cable tension and the spool can be changed to altered to counteract the vertical component of the cable tension.

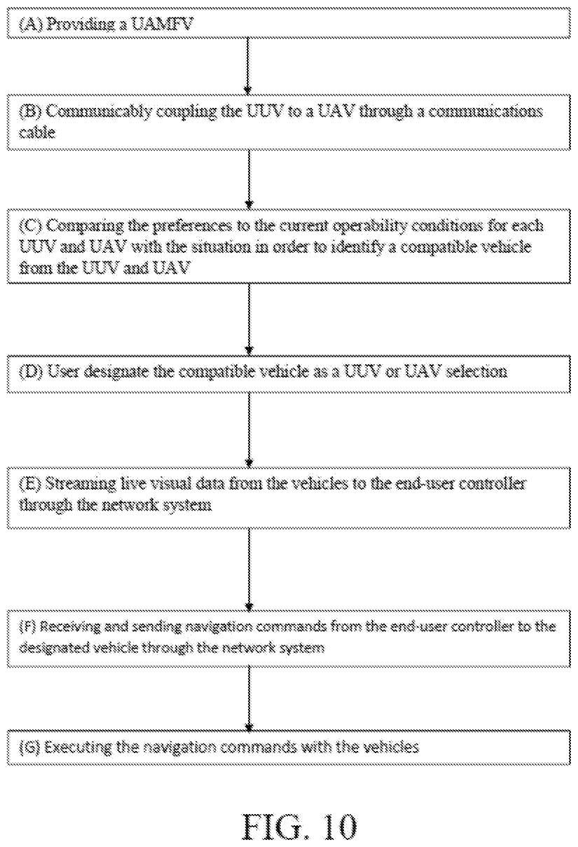

With reference to FIG. 10 this is the general process of operating the present invention, each the UAV and UUVs is associated with a plurality of current operability conditions. The current operability conditions reflect the current viability of an end user gaining control of one of the vehicles through the present invention based on several factors including functionality of the vehicles, weather conditions, distance, whether a given vehicle is currently in use, current battery level, and preferences expressed by an end user making a request to pilot a vehicle.

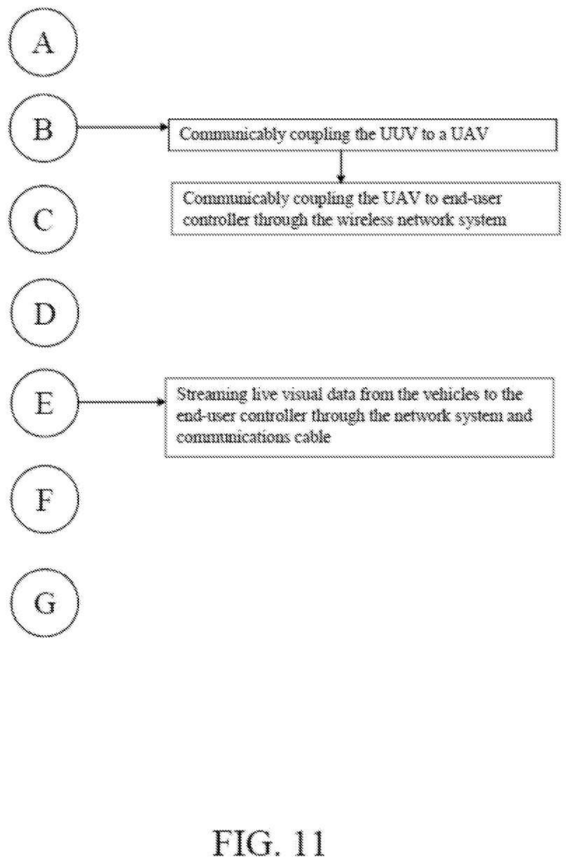

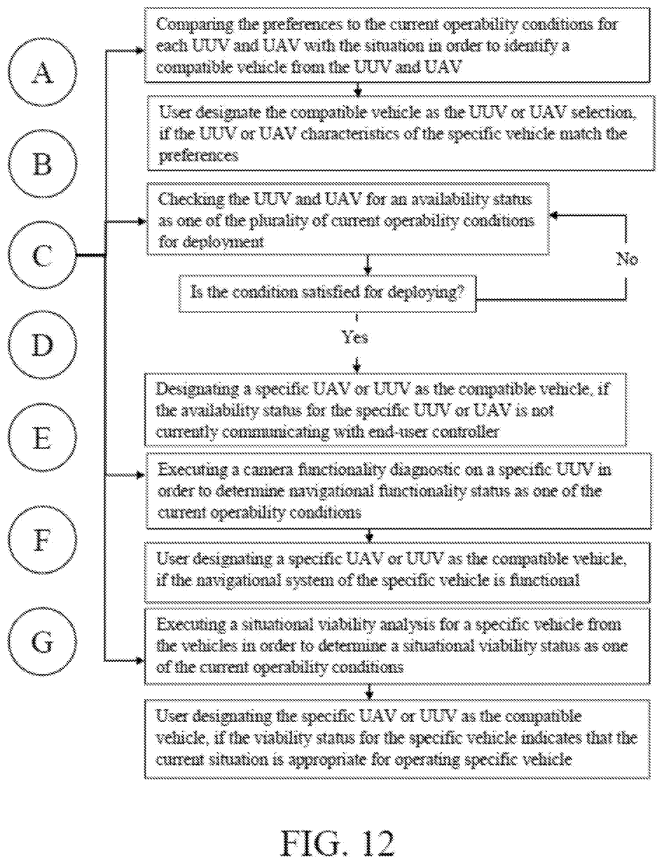

In one embodiment the UAMFVs is communicably coupled to the controller through the wireless network 61. In the preferred embodiment as described in FIG. 11, each of the UAV and UUV is communicably coupled, and the UAV transceivers is communicably coupled to the controller through a wireless network 61. Preferences for the UAV selection are received from an end-user controller. The preferences are compared to the current operability conditions for each of the UAMFVs vehicles with the controller system in order to identify if the UAV can be deployed from the UAV. The user selects the UAV, once the vehicle is found according to the current operability conditions. The end-user is then provided with control of the compatible vehicle. Live visual data is streamed from the UUV transceivers through the wired link 5 or a wireless network 71 to the UAV 2. In one embodiment, live audio data is streamed from both the UAV and UUV to the end-user controller through the wireless system 61. Navigation commands are sent from the end-user controller 6 to the compatible vehicle through the communications networks, the navigation commands are executed with the compatible vehicle.

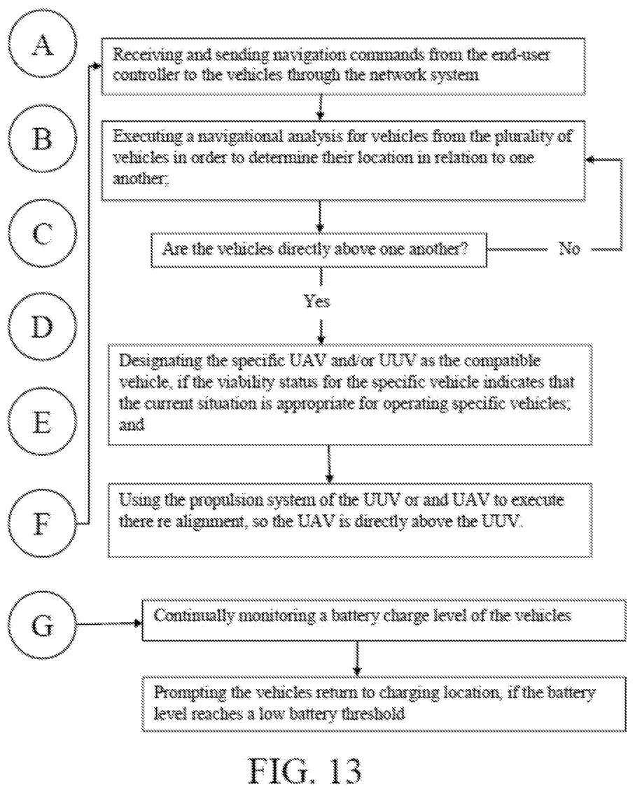

In reference to FIG. 12, a number of analyses are executed on the UUV and UAV in order to determine the status of the current operability conditions. The vehicles are checked for an availability status as one of the plurality of current operability conditions. In order for the UUV to be chosen as the compatible vehicle, a camera functionality diagnostic is executed on the UUV. in order to determine a camera functionality status as one of the current operability conditions. A navigation functionality diagnostic is executed on the UAV and UUV in order to determine a navigation functionality status as one of the current operability conditions. A situational viability analysis is executed for the UUV and UAV in order to determine a situational viability status as one of the current operability conditions. In one embodiment of the present invention, said analyses are performed continually or intermittently in order to keep a continually updated status for each of UAV and UUV, or the analyses are performed when the preferences are received from the end-user, or both.

If the UUV characteristics matches the preferences, the camera functionality status for the UUV indicates the camera of the UUV is functional, if the navigation functionality status for the UAV and UUV indicates that the navigation system is functional, and if the situational viability status for the UAV and UUV indicates that the current situation is appropriate for operating the UUV, the UUV is designated as the compatible vehicle, and the end-user is granted control of the specific UUV.

In one embodiment referenced in FIG. 13, the system continuously estimates the position of the UUV by adding the length of the cable in the direction of the cable from the UAV. The system can then use a pressure transducer signal from the UUV to determine its depth. Based upon these calculations, the system can accurately determine the position of the UUV. and the compatible vehicle is prompted to re align the vehicles directly above one another if the distance between the UAV and UUV reaches a distance threshold.

In one embodiment referenced in FIG. 13, a battery charge level is continually monitored for the compatible vehicle, and the compatible vehicle is prompted to return to a charging location if the battery charge level reaches a low battery threshold.

The present invention has been described as having a rechargeable lithium battery which can limit the duration of the UAV and UUV operations. In an alternative embodiment, the UAV 2 or/and UUV 4 can have the energy source such as an electrical power supply, electrical generator, Solar cells, etc. In this embodiment, the cable can include electrical conductors that provide a low resistance transmission of electrical power through cable to the UUV.

While the invention has been described herein with reference to certain preferred embodiments, these embodiments have been presented by way of example only, and not to limit the scope of the invention. Accordingly, the scope of the invention should be defined only in accordance with the claims that follow.

What is claimed is:

1. A apparatus for unmanned aerial maritime float vehicle that sense and report relevant data from physical and operational environment vehicle comprising
A UAMFV comprising:
A propulsion system for allowing ascent, descent and travel of a UAMFV above a ground surface, also across water surface;
A landing gear structure mounted to said main body, said landing gear includes floats to allow stabilization to main body upon landing on surfaces;
A winch to ascend and descend the cable from a UAV;
A cable to enable a position at which a towing force is applied;
A winch attachment point for allowing ascent, descent of a cabled UUV between positions;
A power supply to provide electricity to wireless vehicle/vehicles;
A UUV housing to allow the encase sensors protection during submersion in water and a attachment point for a cable;
A UAV housing sensors to allow relevant data to be collected from above water;
A UUV housing sensors to allow relevant data to be collected from under water;
A controller to allow wireless commands to be communicated to the vehicles and receive feedback from vehicles;
A transceiver on a UAV for communication signals to be sent or received from a UUV;
A transceiver on a UAV to transmit received signals from a UUV to a wireless linked controller; and
A transceiver on a controller to transmit or receive signals from both the UAV and UUV.

2. The apparatus of claim 1 comprising:
The UAV;
A UAV includes sensors and sensor data is transmitted at a data transfer rate of about 1-12 mbps from the unmanned aerial vehicle to the end-user controller;
A winch to extract and insert the cabled UUV in to the water;
A compilation of housed sensors to report relevant data;
A cable coupled between a remotely operated underwater vehicle and remotely operated aerial vehicle;
A winch on the remotely operated aerial vehicle is releasing cable from the control vessel as the remotely operated underwater vehicle travels deeper into the body of water;
A winch on aerial vehicle is reeling in cable as the remotely operated underwater vehicle travels towards the surface of the body of water;
A winch wherein storing the cable;
A landing gear structure mounted to said main body, said landing gear includes floats to allow stabilization to main body upon landing on surfaces;
A aerial propulsion system configured to lift the UAV and UUV of the ground and navigate the sky, and said propulsion system including a plurality of rotors each mounted to the end a boom attached to and extending from the main body;
A optional power supply to provide electricity to both wireless vehicles or vehicle; and
A transceiver configured to at least one of: transmit the sensors data on the other vehicle to a remote operator, to receive movement instructions from the remote operator, and to implement movement instructions utilizing the propulsion system.

3. The apparatus of claim 2 wherein, the UAV transmits and/or receives radio signals data and/or electrical power to a remotely operated underwater vehicle.

4. The apparatus of claim 2 wherein, the winch raises or lowers the UUV from the UAV;

5. The apparatus of claim 2 wherein, the propulsion system is used to lift and navigate the vehicles through the air.

6. The apparatus of claim 2 wherein, the floats and landing gear allow for floatation on water surfaces and stabilization on surfaces;

7. The apparatus of claim 2 wherein, the UAV uses it propulsion system to tow the UUV;

8. The apparatus of claim 2 wherein, the UAV transceiver sends both the signals from UAV and UUV transceiver to controller through wireless signals;

9. The apparatus of claim 1 comprising:
The UUV;
A UUV includes sensors and sensor data is transmitted at a data transfer rate of about 1-12 mbps from the unmanned underwater vehicle to the unmanned aerial vehicle;
A remotely operated underwater vehicle sensors retrieve relevant data;
A transceiver configured to at least one of: transmit the sensors data on the other vehicle to a remote operator, to receive movement instructions from the remote operator, and to implement movement instructions utilizing the propulsion system;
A remotely operated underwater vehicle includes sensors and sensor data is transmitted at a data transfer rate of about 1-12 mbps through the remotely operated aerial vehicle transceiver and through the wireless link to the end-user controller;
A optional power supply to provide electricity to wireless vehicles or vehicle;
A optional propulsion system may be used to move the vehicle movement through the water; and
A cable coupled between the remotely operated aerial vehicle and a remotely operated underwater vehicle.

10. The apparatus of claim 10 wherein, the UUV sends and/or receives radio signals, data and/or electrical power to a UAV.

11. The apparatus of claim 10 wherein, a attached propulsion system is used to tow a UAV across water surfaces;

12. The apparatus of claim 10 wherein, it may auto-pilots itself through a body of water to stay directly below a UAV.

13. The apparatus of claim 10 where, it is coupled to a UAV, specialized connector to allow it to be easily connected and disconnected from the UUV and communications equipment on the UAV.

14. The apparatus of claim 1 comprising:
The controller;
A controller capable of determining the correct condition for deploying the UUV;
A controller includes sensors and sensor data is transmitted/received at a data transfer rate of about 1-12 mbps from the remotely operated aerial vehicle transceiver through the wireless link;
A controller capable of determining the locations of the two vehicles; and
A controller capable of streaming live visual data from the vehicles through the network system.

15. The apparatus of claim 13 wherein, the controller is configured to at least one of: send and receive live data and record data pertaining to the vehicles data collected and vehicle actions.

16. The apparatus of claim 13 wherein, the controller includes sensors and sensor data is transmitted/received at a data transfer rate of about 1-12 mbps from the remotely operated aerial vehicle transceiver through the wireless link.

17. A method for providing operating access to remotely accessible unmanned aerial maritime float vehicle that sense and report relevant data from physical and operational environment comprising the steps of; and
Communicably coupling a UAV to a end user controller through a wireless link;
Communicably coupling a UUV to a UAV;
Comparing the preferences to the current operability conditions for each UUV and UAV with the situation in order to identify a compatible vehicle from a UUV and UAV;
Designate the compatible vehicle as a UUV or UAV selection;
Streaming live visual data from the vehicles to the end-user controller through the wireless link;
Receiving and sending navigation commands from the end-user controller to the vehicles; and
Executing the navigation commands with the vehicles.

18. A method for providing operating access to remotely accessible unmanned aerial maritime float vehicle that sense and report relevant data from physical and operational environment as claimed in claim 16 comprising the steps of;
Comparing the preferences to the UUV and/or UAV characteristics; and
Designating the UUV and/or UAV as the compatible vehicle, if the UUV or UAV characteristics specific UUV and/or UAV match the preferences.

19. A method for operating remotely accessible unmanned aerial maritime float vehicle that sense and report relevant data from physical and operational environment as claimed in claim 1 comprising the steps of;
Streaming live visual data from the vehicles to the end-user controller through the wireless link;
Take off from a surface and remotely navigate UAMFV's UAV to the area of interest;
Landing the UAMFV on a water surface;
Deploying the cabled UAMFVS's UUV into the water;
Remotely controlling the cabled UAMVS's UUV to area of interest;
Extract the cabled UAMFV's UUV out the water; and
Take off from water surface and remotely navigate UAMFV's UAV to the charging location.

20. A method for unmanned aerial maritime float vehicle to auto pilot itself to be directly above the deployed unmanned underwater vehicle as claimed in claim 13 comprising the steps of;
Receiving and sending navigation commands from the end-user controller to the vehicles through the network system;
Executing a navigational analysis from the vehicles in order to determine their location in relation to one another;
Designating the specific UAV and/or UUV as the compatible vehicle, if the viability status for the specific vehicle indicates that the current situation is appropriate for operating specific vehicles; and
Either using the propulsion system of the UUV or and UAV to execute there realignment, so the UAV and the UUV are directly above one another.
